(19) United States
(12) Patent Application Publication
(10) Pub. No.: US 2004/0174562 A1
(43) Pub. Date: Sep. 9, 2004

(54) Method and apparatus for image processing ordering utilizing a scanned proof-less order form to generate image order information

(76) Inventor: Mark J. Edwards, Lexington, KY (US)

Correspondence Address: LEXMARK INTERNATIONAL, INC., INTELLECTUAL PROPERTY LAW DEPARTMENT, 740 WEST NEW CIRCLE ROAD, BLDG. 082-1, LEXINGTON, KY, 40550-0999, US

(21) Appl. No.: 10/378,179

(22) Filed: Mar. 3, 2003

(51) Int. Cl. G06F 15/00

(52) U.S. Cl. 358/1.18; 358/1.1

(57) ABSTRACT

A system and method for enabling a user to select for additional processing a digital image, utilizing an apparatus containing a printer and a scanner, is disclosed, which may comprise: an order form generator adapted to generate a proof-less order form having at least one image order selection designation area, each of the at least one image order selection designation areas printed on the proof-less order form spatially accompanying one of a plurality of image identifiers, each image identifier corresponding to an image that is available for designation as being selected, without the reproduction of any graphical representation of the respective image itself on the order form; and an order processing apparatus adapted to scan the proof-less order form and interpret image order selection information associated with each of the plurality of image identifiers and to generate image selection information for further image processing. The at least one image order selection designation area may be a plurality of image order selection designation areas and the order processing apparatus may also be adapted to interpret the content of the respective image order selection designation areas to generate an image selection and image parameter selection information for further image processing. The at least one image order selection designation area may represent a parameter selected from a group comprising order image, image size, image bordering, contrast, brightness, image background, color balance, number of reproductions of each image, number of reproductions per page, rotation and cropping. The apparatus containing the scanner and printer may be a multifunction device. The multifunction device may be in data communication with a local host computer and the images selected for processing are stored on memory contained in the local host computer or may be downloaded from a remote data storage facility.

### BACKGROUND OF THE INVENTION

It is known to provide “photo station” capability without the need for providing, e.g., an LCD for previewing the images that the user wishes to print and or otherwise process in some fashion, e.g., selecting the size, background, borders, cropping, brightness and contrast, and the like. Hewlett Packard has on the market an all-in-one device (multifunction device) the HP PSC950, that is the subject of several published US patent applications, including: application Ser. No. 09/767,935 entitled SPECIFYING IMAGE FILE PROCESSING OPERATIONS VIA DEVICE CONTROLS AND A USER-COMPLETED PROOF SHEET, with inventors Monty, Breidenbach, Winter and Hatcher and assigned to Hewlett Packard, with a filing date of Jan. 23, 2001, was published in the United States with a publication number US 20010019416 A1 on Sep. 6, 2001, and is a continuation-in-part of the co-pending U.S. application Ser. No. 09/735,090 by Winter and Hatcher, filed Dec. 12, 2000, titled STORING AND RETRIEVING DIGITAL CAMERA IMAGES VIA A USER-COMPLETED PROOF SHEET, published in the United States under publication No. US 2002-0051201 A1, and for which a notice of allowance was issued on Sep. 23, 2002, which is a continuation-in-part of application Ser. No. 09/173,050, entitled SYSTEM AND METHOD FOR PRINTING AND SCANNING A USER-COMPLETED DIGITAL STILL CAMERA IMAGE PROOF SHEET AND ORDER FORM, with inventors Winter, Epstein and Hilliard, and assigned to Hewlett Packard, with a filing date of Oct. 15, 1998, was published in the United States with a publication number US 20010040685 A1 on Nov. 15, 2001, now abandoned. In addition there is U.S. Published Patent Application No. 20020033965, entitled SYSTEM AND METHOD FOR PRINTING AND SCANNING A USER-COMPLETED DIGITAL STILL CAMERA IMAGE PROOF SHEET AND ORDER FORM, having a U.S. Publication date of Mar. 21, 2002, with inventors Winter, Epstein and Hilliard, corresponding to U.S. application Ser. No. 09/995,869, with a filing date of Nov. 29, 2001, which is also a continuation application of Ser. No. 09/173,050 (U.S. Publication No. 20010040685). At least one of these applications specifically refers to the utilization of a multifunction machine with a scanner element and printer element.

Other art related to photo and/or digital image selection, retrieval, and processing systems are exemplified by, e.g., U.S. Application Ser. No. 90/767935, filed on Jan. 23, 2001 (the “'416 Published Application”); U.S. Patent Application, Pub. No. 0020054765, entitled METHOD OF PROCESSING A ROLL OF EXPOSED PHOTOGRAPHIC FILM CONTAINING PHOTOGRAPHIC IMAGES INTO CORRESPONDING DIGITAL IMAGES AND THEN DISTRIBUTING VISUAL PRINTS PRODUCED FROM THE DIGITAL IMAGES, with inventors Garfinkle, Yaacov and Jaffe, published on May 9, 2002, U.S. application Ser. No. 10/037,810, filed on Nov. 9, 2001; U.S. Patent Application, Pub. No. 20020054768, entitled METHOD OF PROCESSING A ROLL OF EXPOSED PHOTOGRAPHIC FILM CONTAINING PHOTOGRAPHIC IMAGES INTO CORRESPONDING DIGITAL IMAGES AND THEN DISTRIBUTING VISUAL PRINTS PRODUCED FROM THE DIGITAL IMAGES, with inventors Garfinkle, Yaacov and Jaffe, published on May 9, 2002, U.S. application Ser. No. 09/490,341, filed on Jan. 24, 2000; and U.S. Published Patent Application, Pub. No. 20020071678, entitled METHOD OF PROCESSING A ROLL OF EXPOSED PHOTOGRAPHIC FILM CONTAINING PHOTOGRAPHIC IMAGES INTO CORRESPONDING DIGITAL IMAGES AND THEN DISTRIBUTING VISUAL PRINTS PRODUCED FROM THE DIGITAL IMAGES, with inventors Garfinkle, Yaacov and Jaffe, published on Jun. 13, 2002, U.S. application Ser. No. 10/039,547, filed on Nov. 9, 2001; U.S. Pat. No. 5,684,999, entitled APPARATUS AND A METHOD FOR RETRIEVING IMAGE OBJECTS BASED ON CORRELATION WITH NATURAL LANGUAGE SENTENCE PARAMETERS, issued to Okamoto on Nov. 4, 1997, on an application filed on Dec. 2, 1994 claiming priority from Japanese applications filed on Dec. 6, 1993 and Dec. 1, 1994 (the “'999 patent”). Of more general interest, are U.S. Pat. Nos. 5,831,714, issued to Yoshikawa; U.S. Pat. No. 6,154,755, issued to Dellert et al.; U.S. Pat. No. 6,169,596, issued to Shiota; U.S. Pat. No. 6,353,487, issued to Fredlund et al.; and U.S. Pat. No. 6,367,991, issued to Garfinkle et al. and U.S. Published Patent Application Nos. 20010014184, with a named inventor Bubie et al. and 20020052753, with a named inventor Shinkai.

In addition, U.S. Pat. No. 5,479,269, entitled AUTOMATED FORM HANDLING AND GENERATING SYSTEM AND A FORM SHEET ASSOCIATED TO SAID SYSTEM, issued to Bronnenberg, et al. on Dec. 26, 1995, on an application filed on Jul. 12, 1994 claiming priority from an EPO application filed on Apr. 27, 1992 discloses a FAX machine built into a laptop computer, with a scanner and printer element that produces an image in the form of a FAX transmission sheet in response to a printed and then scanned order form having user selection areas for selecting the addressee and also having on the order form a parameter selection designation area to select course or fine transmission of the FAX to the addressee.

Photo station functionality relates mainly to the ability of a user to obtain and manipulate images, e.g., digitally stored images, e.g., digitally stored photo images, for instance as obtained directly from a digital camera compact memory storage card, or indirectly from a storage medium after the image has been downloaded from the flash card into a more permanent form of digital storage, e.g., on a host computer, a server, e.g., at a photo processing shop and/or some centrally located mass storage facility served by a server and accessible, e.g., over the internet or some other network, like a LAN or a WAN, e.g., inside of a company and/or connected to a larger network, like the Internet and accessible in that fashion.

The HP machine referenced above and disclosed in the above referenced US published patent applications refers to utilizing a combination proof sheet and order form that can be produced from the stored digital images with a smaller graphical representation of the image as stored, a so-called thumbnail, along with at least order selection regions and perhaps also including other user selection regions for the user to indicate selection of the image represented by the thumbnail and also perhaps specific processing options, e.g., cropping, size of the reproduction, number of reproductions of the image, number of images per page, etc. The image thumbnails along with the accompanying selection regions may be printed by, e.g., a multifunction device and then the selections regions, e.g., boxes or so-called bubbles can be filled in by the user and scanned to obtain the order information related to each image, selected or not selected, and then used to process the image and return the processed image to the user. This can be done, e.g., by the user at the user's own printer, or a photo processing outlet, e.g., in a department store or a mall kiosk, or involve downloading by the user or the photo processing outlet from a central data storage repository, in a wide variety of possible links and communications opportunities, including, e.g., a wireless or other connection of such tools as a personal digital assistant or even a cell phone with a small LCD display, as are all well known.

A disadvantage of the HP system is that the reproduction of the thumbnails occupies a great deal of space and also time and data information, e.g., when moving the order form around on the internet, or even from a local host to the multifunction machine for purposes of either making or processing the order form. In addition, as the number of images reproduceable, e.g., even from a single flash card memory continues to rise, the need using the HP machine is for multiple order forms, sometimes many multiples of order forms for processing a single order.

The present invention alleviates the adverse effects of the shortcomings of the prior art.

### SUMMARY OF THE INVENTION

A system and method for enabling a user to select for additional processing a digital image, utilizing an apparatus containing a printer and a scanner, is disclosed, which may comprise: an order form generator adapted to generate a proof-less order form having at least one image order selection designation area, each of the at least one image order selection designation areas printed on the proof-less order form spatially accompanying one of a plurality of image identifiers, each image identifier corresponding to an image that is available for designation as being selected, without the reproduction of any graphical representation of the respective image itself on the order form; and an order processing apparatus adapted to scan the proof-less order form and interpret image order selection information associated with each of the plurality of image identifiers and to generate image selection information for further image processing. The at least one image order selection designation area may be a plurality of image order selection designation areas and the order processing apparatus may also be adapted to interpret the content of the respective image order selection designation areas to generate an image selection and image parameter selection information for further image processing. The at least one image order selection designation area may represent a parameter selected from a group comprising, e.g., order image, image size, image bordering, contrast, brightness, image background, color balance, number of reproductions of each image, number of reproduction per page, rotation and cropping. The apparatus containing the scanner and printer may be a multifunction device. The multifunction device may be in data communication with a local host computer and the images selected for processing may be stored on memory contained in the multifunction device or printer, or the local host computer, or may be downloaded from a remote data storage facility.

### BRIEF DESCRIPTION OF THE DRAWING

FIG. 1 shows a well known system for the selection, retrieval and processing of images, particularly digitally stored images, in a variety of ways;

FIG. 2 shows a combination of proof sheets and an order form according to an embodiment of the present invention; and,

FIG. 3 shows an alternative version of the order form useful in the system according to an embodiment of the present invention.

### DETAILED DESCRIPTION OF THE PREFERRED EMBODIMENT

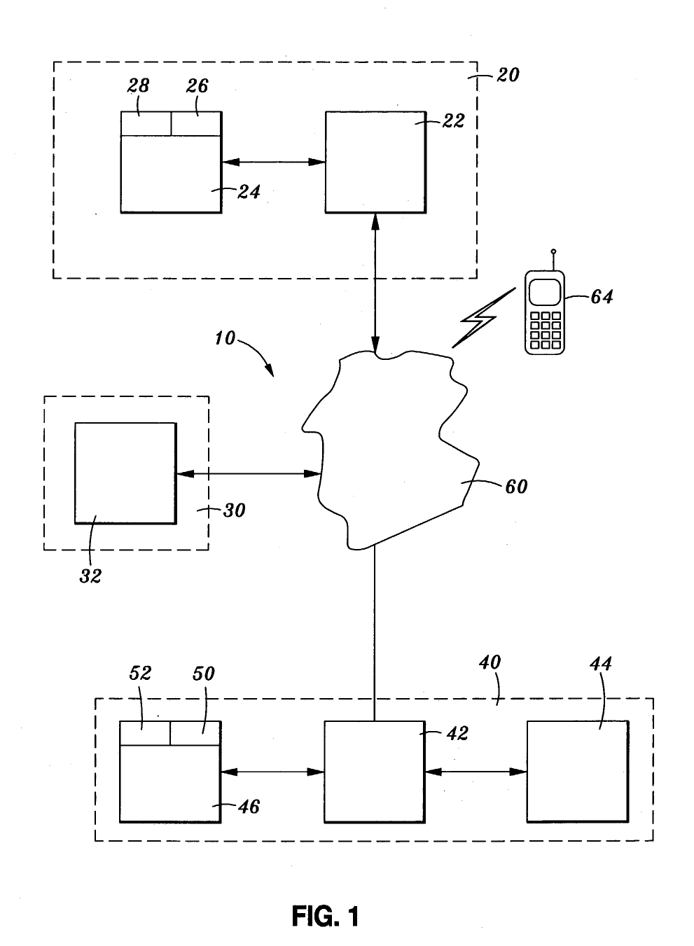

Turning now to FIG. 1, there is shown a system 10 of image selection, retrieval and processing that is representative of the current state of the art. The system can include a local environment 20, e.g., at a user's home or office where a host computer may be used in conjunction with a printer/scanner, e.g., a multifunction machine 24 that includes at least a printer element 26 and a scanner element 28. As is known in the art, the host computer and the printer/scanner may be utilized in a variety of ways to retrieve, select and process images, e.g., digitally stored images, e.g., images contained on or downloaded to either or both of the host computer 22 or the multifunction machine 24, e.g., directly from a digital camera or from a memory card taken from the digital camera. Depending on the configuration of the host computer and/or the multifunction machine, the process may be under control entirely of the host computer 22 in the local environment 20, or the multifunction machine, and the images may be stored locally, e.g., in the hard drive of the local environment host computer 22, downloaded from the camera and sent directly to the multifunction machine 24 or connected from the camera directly to the local environment multifunction machine 24. In the case of multifunction machines with stand alone capabilities, the host computer may be the controller in the multifunction machine.

The system may also include a remote data storage and access location 30 including a remote server 32 at the remote data storage and access location 30 and may be accessible over a network, e.g., as a web-site on the Internet. The system may also include a photo processing outlet environment 40, which may be located as, e.g., a department store or kiosk in a mall or the like, and may include a photoprocessing outlet local host computer 42, a photoprocessing outlet environment 40 local server 44 and associated data storage media (not shown) and a photoprocessing outlet environment 40 local multifunction machine 46 having a printer element 50 and a scanner element 52.

All of the environments 20, 30 and 40 may be interconnected, e.g., over a wired network, e.g., the Internet utilizing, e.g., the public switched telephone network 60 for communication and may also be accessible through a wireless connection to the network, 60 through, e.g., a wireless telephone 64 having a suitable video display.

In operation it will be understood that this system may have various connections and interconnections, for the selection, retrieval and processing of images, e.g., digital images and more specifically, e.g., digital photo images. The host computer 42 at the photoprocessing outlet environment 40 may interact with the local multifunction machine 46 and/or, e.g., a digital camera and/or flash card from such a digital camera in the same fashion as the user interaction for image processing described above in regard to the local environment 20. This may be, e.g., responsive to a customer arriving at the photoprocessing outlet with the camera or flash memory card. In response to the customer coming to the photoprocessing outlet environment 40, the photoprocessing outlet 40 host computer 42 may access records of images stored locally through a local server 44.

Either the local host computer 22 at the local user environment 20 or the photoprocessing environment 40 host computer 42 may access remote storage, e.g., through the remote access environment 30 server 32, e.g., over the Internet or other suitable network. The wireless connection through, e.g., wireless telephone 64 may be used to access and manipulate orders and the like over the system 10.

In all of the above, the HP utilization of a combined proofsheet and order form may be utilized, e.g., at the multifunction machine 24 itself, if it is stand alone capable, or in the interaction between host computer 22 and local multifunction machine 24 at the local user environment, or between the host computer 42 and the local multifunction machine 46 at the photoprocessing outlet location and/or for image selection and retrieval from the remote location responsive to communication from the host computer 22 at the local user environment 20 or from the host computer 42 at the photoprocessing outlet environment 40, or even from communication from the wireless communication through, e.g., wireless phone 64.

It will also be understood that the combined proofsheet and order form of the prior art HP system may be generated and processed or partially processed at only one location or interchanged between locations. For example the combined proofsheet and order form may be generated at the host computer 22 and/or the multifunction machine 24 at the local user environment 20 and be processed by the local host computer 22 and/or local multifunction machine 24 to select, retrieve and process images, e.g., digital photo images entirely within the local user environment 20. Similarly this may all occur totally within, e.g., the photoprocessing outlet 40. In either event the actual images may be retrieved from the remote storage environment 30 and either processed there in response to the selections on the combined proofsheet and order form or processed after selection and retrieval at either the local user environment 20 or at the photoprocessing outlet environment 40. The process may involve combined proofsheet and order forms generated at one location, e.g., the photoprocessing outlet environment, and transmitted to another, e.g., the local user environment 20 or to the wireless phone 64, with a response, i.e., a completed proofsheet and order form returned from the location to which it was transmitted for selection, retrieval and processing of the images, with again access to the remote storage location environment 30, if that is required.

It will also be understood that what is transmitted back and forth, including within the respective local user environment or the photoprocessing outlet environment is electronic versions of the combined proofsheet and order form and the resultant electronic data information gleaned from scanning the completed form registering the selections made in the user selection designation areas for controlling the further image processing.

In all of this operation the combined proofsheet and order form is cumbersome to use, requires much more data transfer to use and requires most often, in ordinary use, the review and designation of selections on numerous such proofsheet and order forms for a given transaction.

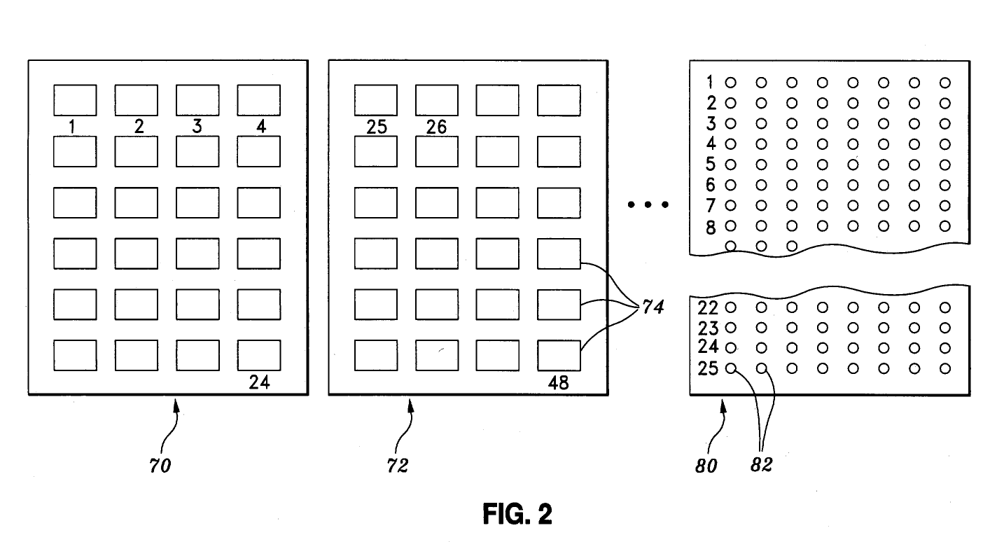

Turning now to FIG. 2 there is shown a system according to an embodiment of the present invention in which is utilized separate proof sheets, 70, 72, on which are contained digital representations of images, e.g., thumbnails 74, each with an identifier, e.g., an alphanumeric designation on any given proofsheet, e.g., numbers 1,2, 3 . . . 48. It will be understood that the proofsheet 70, 72 may have a designation identifying the proofsheet(s) itself (themselves).

The system according to an embodiment of the present invention may then utilize a separate order form 80. On the proof-less separate order form 80 may also be positioned, adjacent a respective image identifier a image selection designation area, such as bubbles 82. As indicated, depending of course upon the image quality of and size of the image proofs, e.g., the thumbnails 74, the order sheet 80 may be utilized to select on one printed and subsequently scanned order form images represented by many proof sheets 70, 72, etc.

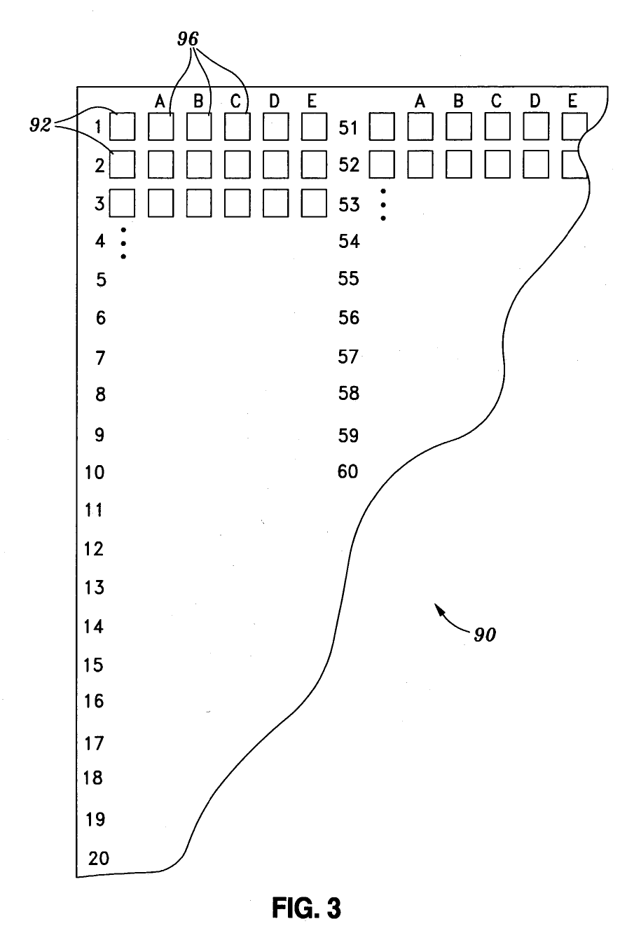

Turning now to FIG. 3, there is shown an alternative embodiment of the present invention represented by a proof-less separate order form 90 that may contain image selection designation areas such as squares 92, and image processing parameter selection designation areas such as squares 96. The designations for, e.g., each column of the image processing parameter selection designation areas such as squares 96 may indicate such processing parameters as number of copies, size of the printed image, background, bordering, brightness, contrast, cropping, etc. It will be understood that, e.g., there may be added processing parameter selection designation boxes 96 for each image selection box 92 for greater levels of granularity of selection and/or the utilization of such known techniques as optical character recognition where the respective box 96 may be scanned and processed according to such techniques as opposed to simply whether or not the respective box 96 is marked for selection or not. Even with the additional user selection designation areas, and also depending upon the scanning recognition of the particular reader that reads the results of the scan of the proof-less separate order form 80, 90, many more orders can be accommodated on a single separate proof-less order form 80, 90 than can be accommodated on a combined proof and order form. This limits the time in carrying out the selection and image processing, e.g., at one single location, and also the time to transmit orders between locations in those instances where that occurs, as described, and may be the only really effective way to handle such selection and orders when the user is interacting with the system through, e.g., a wireless phone 64 or other connection via, e.g., other hand held or laptop or even desktop devices that are, e.g., not physically wired to and/or in the same physical location as the printer that will print the images, whether that be a multifunction device 24, 46, or other printing apparatus (not shown).

The foregoing invention has been described in relation to a presently preferred embodiment thereof. The invention should not be considered limited to this embodiment. Those skilled in the art will appreciate that many variations and modifications to the presently preferred embodiment, many of which are specifically referenced above, may be made without departing from the spirit and scope of the appended claims. For example, images may be actually stored in analog form and converted to digital form once selected for processing and/or in order to be transmitted from a storage location to another location, before or after the selected image processing operations are completed. It will also be understood, e.g. that image and parameter selection, e.g., on the form with only the image selection option or the form with the image selection and parameter selection options spaced with the image designator/image selection box may be considered to be the same. That is, image selection itself, if that is all that the form offers may be considered to be a “parameter” selection, and parameter selection if any such parameter is selected for a given identified image, i.e., without the need for selecting a separate box identified as an image selection box, may itself be the image selection mechanism. That is, further, the image may be designated as selected by designation of one or more of the parameter boxes spaced with the image identifier. The inventions should be measured in scope from the appended claims.

I claim:

1. A system for enabling a user to select for additional processing a digital image, utilizing an apparatus containing a printer and a scanner, comprising:
an order form generator adapted to generate a proof-less order form having at least one image order selection designation area, each of the at least one image order selection designation areas printed on the proof-less order form spatially accompanying one of a plurality of image identifiers, each image identifier corresponding to an image that is available for designation as being selected, without the reproduction of any graphical representation of the respective image itself on the order form; and
an order processing apparatus adapted to scan the proof-less order form and interpret image order selection information associated with each of the plurality of image identifiers and to generate image selection information for further image processing.

2. The system of claim 1 further comprising:
the at least one image order selection designation area is a plurality of image order selection designation areas;
the order processing apparatus is also adapted to interpret the content of the respective image order selection designation areas to generate an image selection and image parameter selection information for further image processing.

3. The system of claim 1 wherein the at least one image order selection designation area represents a parameter selected from a group comprising order image, image size, image bordering, contrast, brightness, image background, color balance, number of reproductions of each image, number of reproductions per page, rotation and cropping.

4. The system of claim 2 wherein the at least one image order selection designation area represents a parameter selected from a group comprising order image, image size, image bordering, contrast, brightness, image background, color balance, number of reproductions of each image, number of reproductions per page, rotation, and cropping.

5. A multifunction device having at least a printer element and a scanner element, for enabling a user to select an image for additional processing, comprising:
an order form generator adapted to generate a proof-less order form having at least one image order selection designation area, each of the at least one image order selection designation areas printed on the proof-less order form spatially accompanying one of a plurality of image identifiers, each image identifier corresponding to an image that is available for designation as being selected, without the reproduction of any graphical representation of the respective image itself on the order form; and
an order processing apparatus adapted to scan the proof-less order form and interpret image order selection information associated with each of the plurality of image identifiers and to generate image selection information for further image processing.

6. The apparatus of claim 5 further comprising:
the at least one image order selection designation area is a plurality of image order designation selection areas;
the order processor is adapted to interpret the content of the respective image order selection designation areas to generate an image selection and image parameter selection information for further image processing.

7. The apparatus of claim 5 wherein the at least one image order selection designation area represents a parameter selected from a group comprising order image, image size, image bordering, contrast, brightness, image background, color balance, number of reproductions of each image, number of reproductions per page, rotation and cropping.

8. The apparatus of claim 6 wherein the at least one image order selection designation area represents a parameter selected from a group comprising order image, image size, image bordering, contrast, brightness, image background, color balance, number of reproductions of each image, number of reproductions per page, rotation and cropping.

9. The apparatus of claim 5 further comprising the multifunction device is in data communication with a local host computer and the images selected for processing are stored on memory contained in the local host computer.

10. A system including the apparatus of claim 5 and further comprising:
a remote data storage facility in data communication with the local host computer and at least one of the images selected for processing is downloaded from the remote image storage facility to the local host computer.

11. A system for enabling a user to select for additional processing a digital image, utilizing an apparatus containing a printer and a scanner, comprising:
an order form generating means for generating a proof-less order form having at least one image order selection designation area, each of the at least one image order selection designation areas printed on the proof-less order form spatially accompanying one of a plurality of image identifiers, each image identifier corresponding to an image that is available for designation as being selected, without the reproduction of any graphical representation of the respective image itself on the order form; and
an order processing means for scanning the proof-less order form and interpreting image order selection information associated with each of the plurality of image identifiers and for generating image selection information for further image processing.

12. The system of claim 11 further comprising:
the at least one image order selection designation area is a plurality of image order selection designation areas;
the order processing means includes means for interpreting the content of the respective image order selection designation areas to generate an image selection and image parameter selection information for further image processing.

13. The system of claim 11 wherein the at least one image order selection designation area represents a parameter selected from a group comprising order image, image size, image bordering, contrast, brightness, image background, color balance, number of reproductions of each image, number of reproductions per page, rotation and cropping.

14. The system of claim 12 wherein the at least one image order selection designation area represents a parameter selected from a group comprising order image, image size, image bordering, contrast, brightness, image background, color balance, number of reproductions of each image, number of reproductions per page, rotation and cropping.

15. A multifunction device having at least a printer element and a scanner element, for enabling a user to select an image for additional processing, comprising:
an order form generating means for generating a proof-less order form having at least one image order selection designation area, each of the at least one image order selection designation areas printed on the proof-less order form spatially accompanying one of a plurality of image identifiers, each image identifier corresponding to an image that is available for designation as being selected, without the reproduction of any graphical representation of the respective image itself on the order form; and
an order processing means for scanning the proof-less order form and interpreting image order selection information associated with each of the plurality of image identifiers and for generating image selection information for further image processing.

16. The apparatus of claim 15 further comprising:
the at least one image order selection designation area is a plurality of image order designation selection areas;
the order processing means includes means for interpreting the content of the respective image order selection designation areas and generating an image selection and image parameter selection information for further image processing.

17. The apparatus of claim 15 wherein the at least one image order selection designation area represents a parameter selected from a group comprising order image, image size, image bordering, contrast, brightness, image background, color balance, number of reproductions of each image, number of reproductions per page, rotation and cropping.

18. The apparatus of claim 16 wherein the at least one image order selection designation area represents a parameter selected from a group comprising order image, image size, image bordering, contrast, brightness, image background, color balance, number of reproductions of each image, number of reproductions per page, rotation and cropping.

19. The apparatus of claim 15 further comprising the multifunction device is in data communication with a local host computer and the images selected for processing are stored on memory contained in the local host computer.

20. A system including the apparatus of claim 15 and further comprising:
a remote data storage facility in data communication with the local host computer and at least one of the images selected for processing is downloaded from the remote image storage facility to the local host computer.

21. A method for enabling a user to select for additional processing a digital image, utilizing an apparatus containing a printer and a scanner, comprising:
generating a proof-less order form having at least one image order selection designation area, each of the at least one image order selection designation areas printed on the proof-less order form spatially accompanying one of a plurality of image identifiers, each image identifier corresponding to an image that is available for designation as being selected, without the reproduction of any graphical representation of the respective image itself on the order form; and
scanning the proof-less order form and interpreting image order selection information associated with each of the plurality of image identifiers and generating image selection information for further image processing.

22. The method of claim 21 further comprising:
the at least one image order selection designation area is a plurality of image order selection designation areas; and the step of interpreting the content of the respective image order selection designation areas to generate an image selection and image parameter selection information for further image processing.

23. The method of claim 11 wherein the at least one image order selection designation area represents a parameter selected from a group comprising order image, image size, image bordering, contrast, brightness, image background, color balance, number of reproductions of each image, number of reproductions per page, rotation and cropping.

24. The method of claim 22 wherein the at least one image order selection designation area represents a parameter selected from a group comprising order image, image size, image bordering, contrast, brightness, image background, color balance, number of reproductions of each image, number of reproductions per page, rotation and cropping.

25. A method of utilizing a multifunction device having at least a printer element and a scanner element, for enabling a user to select an image for additional processing, comprising:
printing a proof-less order form having at least one image order selection designation area, each of the at least one image order selection designation areas printed on the proof-less order form spatially accompanying one of a plurality of image identifiers, each image identifier corresponding to an image that is available for designation as being selected, without the reproduction of any graphical representation of the respective image itself on the order form; and
scanning the proof-less order form and interpreting image order selection information associated with each of the plurality of image identifiers and generating image selection information for further image processing.

26. The method of claim 25 further comprising:
the at least one image order selection designation area is a plurality of image order designation selection areas; and the step of
interpreting the content of the respective image order selection designation areas and generating an image selection and image parameter selection information for further image processing.

27. The method of claim 25 wherein the at least one image order selection designation area represents a parameter selected from a group comprising order image, image size, image bordering, contrast, brightness, image background, color balance, number of reproductions of each image, number of reproductions per page, rotation and cropping.

28. The method of claim 26 wherein the at least one image order selection designation area represents a parameter selected from a group comprising order image, image size, image bordering, contrast, brightness, image background, color balance, number of reproductions of each image, number of reproductions per page, rotation and cropping.

29. The method of claim 25 further comprising establishing a data communication link between the multifunction device and a local host computer and the images selected for processing are stored on memory contained in the local host computer.

30. The method of claim 29 further comprising:
establishing a data communication link with a remote data storage facility and the local host computer and at least one of the images selected for processing is downloaded from the remote image storage facility to the local host computer.
